(19) United States
(12) Patent Application Publication
(10) Pub. No.: US 2026/0138365 A1
(43) Pub. Date: May 21, 2026

(54) LIQUID EJECTION HEAD AND LIQUID EJECTION DEVICE

(71) Applicant: CANON KABUSHIKI KAISHA, Tokyo (JP)

(72) Inventors: TAKASHI KATO, Kanagawa (JP); YOSHIYUKI NAKAGAWA, Kanagawa (JP); AYAKO IWASAKI, Kanagawa (JP); MASATAKA SAKURAI, Kanagawa (JP)

(21) Appl. No.: 19/310,445

(22) Filed: Aug. 26, 2025

(30) Foreign Application Priority Data
Aug. 27, 2024 (JP) 2024-145472

(51) Int. Cl. B41J 2/045; B41J 2/14; B41J 2/18

(52) U.S. Cl. CPC B41J 2/04541; B41J 2/04531; B41J 2/04546; B41J 2/04548; B41J 2/0458; B41J 2/14072; B41J 2/14145; B41J 2/18; B41J 2002/14491

(57) ABSTRACT

A liquid ejection head includes a flow passage forming portion including an ejection port through which liquid is ejected, a pressure chamber communicating with the ejection port, and an individual flow passage communicating with the pressure chamber; a first energy generating element provided at a position corresponding to the pressure chamber of the flow passage forming portion, the first energy generating element configured to generate energy for ejecting the liquid from the ejection port; a second energy generating element provided at a position corresponding to the individual flow passage of the flow passage forming portion, the second energy generating element configured to generate energy for causing the liquid to flow through the individual flow passage; and a selection driving circuit configured to determine whether to drive the second energy generating element depending on whether to drive the first energy generating element.

### BACKGROUND

### Field of the Technology

The present disclosure relates to a liquid ejection head and a liquid ejection device including the liquid ejection head.

### Description of the Related Art

A circulation type liquid ejection device is known which circulates ink in order to discharge air bubbles in a flow passage in a liquid ejection head and suppress an increase in viscosity of ink near an ejection port. The circulation type liquid ejection device may be configured to have, as a circulation mechanism for circulating ink, a circulation flow passage communicating with the ejection port in the liquid ejection head and an energy generating element that generates energy to circulate the ink.

Japanese Translation of PCT Application No. 2013-544678 discloses the following configuration. The circulation type liquid ejection device is provided with an ejection element for ejecting liquid from an ejection port, a pump element for circulating liquid in the circulation flow passage, and a driving circuit for independently driving each of the ejection element and the pump element.

In the above-mentioned configuration, the ejection element and the pump element are configured to be addressed separately, and driving data for driving each of the ejection element and the pump element are separately required. Therefore, as the number of ejection elements and pump elements increases, an amount of data to be used increases accordingly.

### SUMMARY

The present disclosure is directed to reducing the amount of data for driving the liquid ejection head.

According to some embodiments, the liquid ejection head of the present disclosure is characterized by features including:
a flow passage forming portion including an ejection port through which liquid is ejected, a pressure chamber communicating with the ejection port, and an individual flow passage communicating with the pressure chamber;
a first energy generating element provided at a position corresponding to the pressure chamber of the flow passage forming portion, the first energy generating element is configured to generate energy for ejecting the liquid from the ejection port;
a second energy generating element provided at a position corresponding to the individual flow passage of the flow passage forming portion, the second energy generating element is configured to generate energy for causing the liquid to flow through the individual flow passage; and
a selection driving circuit configured to determine whether to drive the second energy generating element depending on whether to drive the first energy generating element.

According to the present disclosure, the amount of data for driving the liquid ejection head can be reduced.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views illustrating a schematic configuration of a liquid ejection device according to a first embodiment;

FIG. 2 is a block diagram illustrating a control system of the liquid ejection device according to the first embodiment;

FIGS. 3A to 3D are explanatory diagrams of a liquid ejection head according to the first embodiment;

FIGS. 4A to 4D are explanatory diagrams of a straight type flow passage configuration;

FIGS. 5A to 5C are explanatory diagrams of a principle of generation of a circulation flow of ink;

FIGS. 6A to 6D are explanatory diagrams of states of concentration of ink in a straight type individual flow passage;

FIGS. 7A to 7D are explanatory diagrams of states of concentration of ink in a U-shape type individual flow passage;

FIGS. 8A to 8C are explanatory diagrams of a U-shape type flow passage configuration;

FIG. 9 is a block diagram illustrating a configuration of a selection driving circuit according to a comparative configuration;

FIG. 10 is a block diagram illustrating a configuration of a selection driving circuit according to the first embodiment;

FIGS. 11A to 11C are schematic diagrams of the vicinity of ejection ports of a liquid ejection head according to a second embodiment;

FIGS. 12A to 12C are diagrams illustrating examples of an arrangement of wirings of the selection driving circuit;

FIGS. 13A to 13C are schematic diagrams of the vicinity of ejection ports of a liquid ejection head according to a third embodiment;

FIGS. 14A and 14B are schematic diagrams of the vicinity of ejection ports of a liquid ejection head according to a fourth embodiment;

FIGS. 15A and 15B are schematic diagrams of the vicinity of ejection ports of a liquid ejection head according to a fifth embodiment;

FIGS. 16A to 16C are schematic diagrams of the vicinity of ejection ports of a liquid ejection head according to a sixth embodiment; and

FIGS. 17A and 17B are schematic diagrams of the vicinity of ejection ports of a liquid ejection head according to a seventh embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

The present disclosure relates to a recording element unit provided in a liquid ejection head that ejects liquid onto a recording medium to perform recording or the like. The present disclosure can be desirably applied to, for example, a recording element unit of an inkjet head provided in an inkjet-recording type inkjet printer that performs recording by foaming liquid such as ink due to thermal energy. However, the recording element unit of the present disclosure is not limited thereto, and is applicable to recording element units of various liquid ejection heads that eject liquid using thermal energy.

Hereinafter, description will be given of a liquid ejection head according to the embodiments of the present disclosure and a liquid ejection device provided with the liquid ejection head, with reference to the drawings. In the following embodiments, a specific configuration of the liquid ejection head that ejects ink will be described, but the present disclosure is not limited thereto. The liquid ejection head of the present disclosure can be applied to devices such as printers, copiers, facsimiles with communication systems, word processors with printer portions, and industrial recording devices combined with various processing devices. For example, the liquid ejection heads can also be used for applications such as biochip production and electronic circuit printing.

### First Embodiment

A liquid ejection device 50 according to a first embodiment of the present disclosure will be described. The liquid ejection device 50 is an inkjet recording device using an inkjet recording method, and includes a liquid ejection head 1 capable of ejecting ink as the liquid.

### Liquid Ejection Device

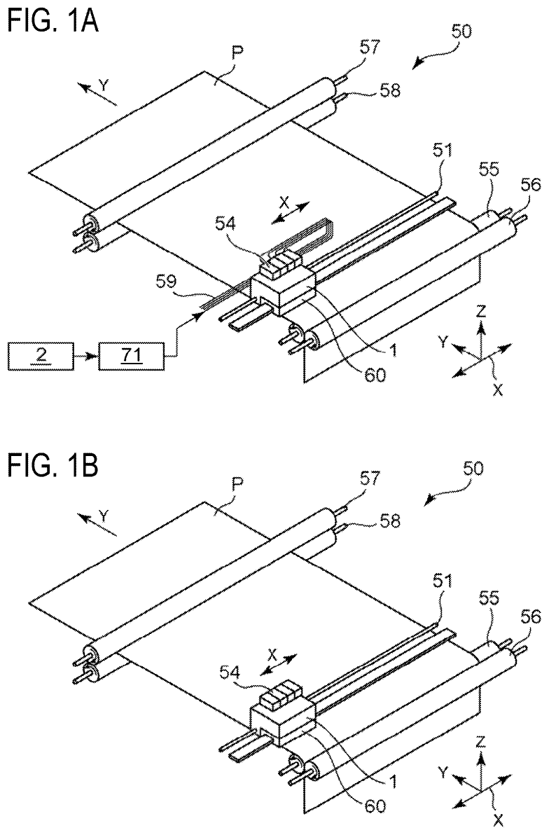

A schematic configuration of the liquid ejection device 50 according to the first embodiment will be described. FIGS. 1A and 1B are perspective views illustrating an example of a configuration of a recording portion of the liquid ejection device 50. The liquid ejection device 50 is a serial type liquid ejection device that performs image recording by ejecting liquid onto a recording medium P using a liquid ejection head 1 that scans in a direction intersecting with a conveyance direction of the recording medium P.

Note that the application of the present disclosure is not limited to the serial type liquid ejection device. For example, the present disclosure is also applicable to a page wide type liquid ejection device that records an image by ejecting liquid onto a recording medium being conveyed in the conveyance direction using a line head (page wide type head) long in the page width direction of the recording medium.

The liquid ejection head 1 is capable of ejecting four types of inks, black (K), cyan (C), magenta (M), and yellow (Y), and full-color images can be recorded using the inks. The inks that can be ejected from the liquid ejection head are not limited to the four types of inks described above. The present disclosure is also applicable to liquid ejection heads for ejecting other types of inks. That is, the types and the number of inks ejected from the liquid ejection head are not limited.

In the following description, the scanning direction (movement direction) of the liquid ejection head 1 is the X direction, the conveyance direction of the recording medium P in the recording portion is the Y direction, and the vertical direction is the Z direction. The X direction, the Y direction, and the Z direction intersect with one another (in the present example, the directions are perpendicular to one another). In some cases, the scanning direction (movement direction) of the liquid ejection head 1 may be referred to as a main scanning direction, and the conveyance direction of the recording medium P may be referred to as a sub-scanning direction.

In the serial type liquid ejection device 50, the liquid ejection head 1 is mounted on a carriage 60. The carriage 60 moves back and forth along a guide shaft 51 in the main scanning direction (X direction). The recording medium P is conveyed in the sub-scanning direction (Y direction) that intersects with (in the present example, perpendicular to) the main scanning direction by conveyance rollers 55, 56, 57, and 58 that constitute a conveyance portion (conveyance means).

FIG. 1A is a perspective view illustrating an example of a configuration in which a main ink tank 2 as a liquid retention portion is provided in a device body (outside the liquid ejection head 1) of the liquid ejection device 50, and a sub-ink tank 54 is provided in the liquid ejection head 1. The liquid (ink) retained in the ink tank 2 is supplied to the sub-ink tank 54 on the liquid ejection head 1 side through an ink supply tube (liquid communication path) 59 due to driving force of an external pump 71. That is, in the example illustrated in FIG. 1A, a device body of the liquid ejection device 50 and the liquid ejection head 1 are each provided with a liquid storage portion for storing ink.

FIG. 1B is a perspective view illustrating a configuration example in which the main ink tank 2 is not provided and the ink tank 54 is provided directly above the liquid ejection head 1. In such a case, the liquid ejection head 1 may be provided integrally with the ink tank 54 and configured to be removable and attachable to the carriage 60. Alternatively, the liquid ejection head 1 may be configured to be provided integrally with the carriage 60 and only the ink tank 54 may be removable and attachable thereto. Hereinafter, description will be given using the configuration of FIG. 1A as a representative example.

The liquid ejection head 1 is configured to include individual ejection units to be described later. A specific configuration thereof will be described later, but the individual ejection unit is a recording element unit in which an ejection port for ejecting liquid, a pressure chamber communicating with the ejection port, and an individual flow passage communicating with the pressure chamber are formed. The individual ejection unit also includes a first energy generating element (ejection energy generating element) that generates energy for ejecting liquid from the ejection port, and a second energy generating element (flow energy generating element) that generates energy for causing liquid to flow through the individual flow passage. The first energy generating element is provided at a position corresponding to the pressure chamber, and the second energy generating element is provided at a position corresponding to the individual flow passage. The liquid ejection head 1 has a plurality of individual ejection units, and has a supply flow passage for supplying liquid to the individual flow passage in each individual ejection unit.

When the liquid ejection head 1 is used, ejection of liquid may become unstable due to evaporation of volatile components such as water at the ejection port and the resulting solid content concentration near the ejection port. Thus, various measures have been taken to prevent the ejection from becoming unstable. For example, the liquid ejection device 50 may be provided with a cap member (not illustrated) at a position away from the conveyance path of the recording medium P in the X direction. The cap member is capable of covering the ejection port surface on which the ejection ports of the liquid ejection head 1 are formed. The cap member is used to prevent the ejection ports from drying and to protect the ejection ports by covering the ejection port surface of the liquid ejection head 1 when the recording operation is not being performed.

Further, the liquid ejection device 50 may be provided with an ink suction mechanism (not illustrated). The cap member with the ink suction mechanism is used for the operation of suctioning ink from the ejection ports. By performing the ink suction operation, the ink near the ejection ports can be refreshed, and the quality of the image obtained can be maintained.

Further, when the recording operation is not being performed, the concentrated ink may be discarded by performing ejection called preliminary ejection (pre-ejection). Furthermore, even during the recording operation, an inconspicuous amount of ink may be preliminarily ejected (may be subjected to either paper preliminary ejection or intra-page preliminary ejection) at a position on the recording medium that is not noticeable in terms of image quality. Although such methods contribute greatly to improving image quality, it is necessary to minimize an amount of waste ink since some ink is discarded to refresh the ejection ports.

To solve such a problem, a second energy generating element (flow energy generating element) is provided in the individual flow passage and the ink is circulated in the flow passage. Thereby, it is possible to prevent the ejection port from being dried and prevent the ink near the ejection port from being concentrated while minimizing the amount of waste ink. More specifically, the number of preliminary ejection operations and the number of suction recovery operations can be reduced as much as possible. Further, by reducing the number of preliminary ejection operations and the like, the throughput and yield thereof can be improved.

The second energy generating elements (flow energy generating elements) do not necessarily have to be provided in all individual ejection units of the liquid ejection head. When the elements are provided in some of the individual ejection units, the above-mentioned effect can be obtained compared to a case where the elements are not provided.

Further, the liquid ejection head 1 may be configured such that all locations corresponding to the four types of ink are provided with the second energy generating elements, or such that only a location corresponding to one type of ink is provided with the second energy generating element. In other words, the liquid ejection head may be configured to not circulate all the four types of ink but only at least one type of ink.

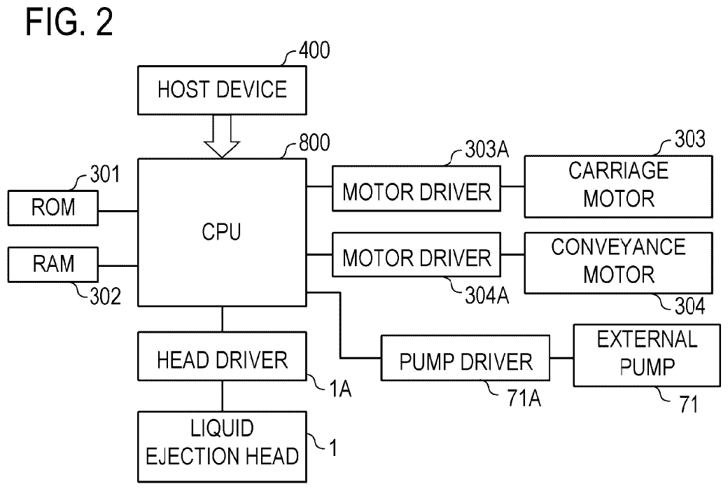

FIG. 2 is a block diagram illustrating a control system of the liquid ejection device 50. A CPU 800 is a control portion that controls an operation of each portion of the liquid ejection device 50 on the basis of a program such as a processing procedure stored in a ROM 301. A RAM 302 is used as a work area or the like when the CPU 800 executes processing. The CPU 800 receives image data from, for example, a host device 400 outside the liquid ejection device 50, and controls a head driver 1A on the basis of the image data to control the driving of the ejection elements provided in the liquid ejection head 1.

The CPU 800 also controls drivers of various actuators provided in the liquid ejection device 50. For example, the CPU 800 controls a motor driver 303A of a carriage motor 303 for moving the carriage 60, a motor driver 304A of a transport motor 304 for conveying the recording medium P, a pump driver 71A of the external pump 71, and the like. Note that although FIG. 2 shows a form in which image data received from the host device 400 is processed, the liquid ejection device 50 may perform processing without depending on data sent from the host device 400.

### Liquid Ejection Head

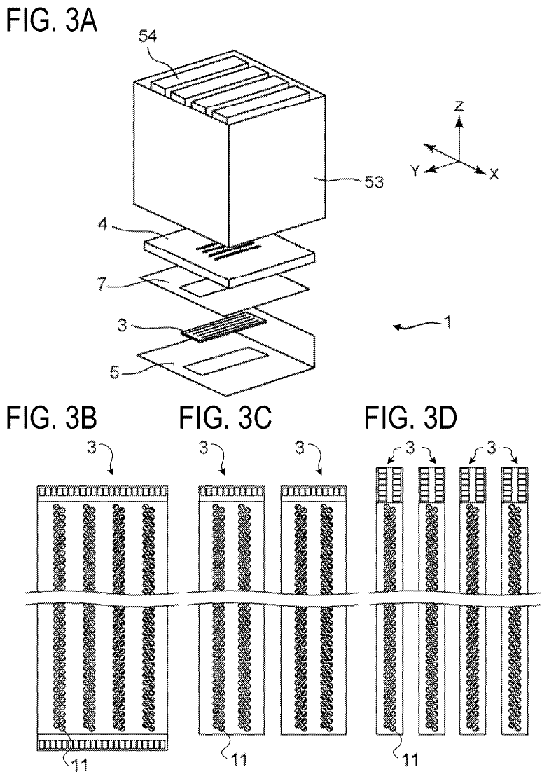

An example of a configuration of the liquid ejection head 1 will be described. FIGS. 3A to 3D are explanatory diagrams of the liquid ejection head 1 according to the first embodiment. FIG. 3A is an exploded perspective view of the liquid ejection head 1.

The liquid ejection head 1 includes four sub-ink tanks 54 that temporarily retains inks in the head, and liquid ejection chip 3 that ejects the inks supplied from the sub-ink tanks 54 onto the recording medium P.

The liquid ejection head 1 further includes a first supporting member 4, a second supporting member 7, and an electric wiring member (electric wiring tape) 5. The liquid ejection chip 3 is connected to one surface of the first supporting member 4, and the ink tanks 54 are connected to the other surface. A flow passage, which penetrates from one surface to the other surface opposite to the one surface, is formed in the first supporting member 4. The first supporting member 4 supports the liquid ejection chip 3 while sending the inks supplied from the ink tanks 54 to the liquid ejection chip 3.

The second supporting member 7 is connected to a connection surface of the first supporting member 4 connected to the liquid ejection chip 3. The second supporting member 7 has an opening through which the liquid ejection chip 3 can be inserted, and is connected to the first supporting member 4 such that the liquid ejection chip 3 is located in the opening. Further, the second supporting member 7 supports the electric wiring member 5.

The electric wiring member 5 is electrically connected to the liquid ejection chip 3, and sends an ejection signal that is for ejecting ink and that is sent from the device body of the liquid ejection device 50 or the like to the liquid ejection chip 3.

The liquid ejection head 1 according to the first embodiment is fixedly supported on the carriage 60 of the liquid ejection device 50 by a positioning means and an electric contact (not illustrated) provided on the carriage 60. The liquid ejection head 1 ejects the ink while moving in the main scanning direction (X direction) together with the carriage 60, and performs recording on the recording medium P.

Ink supply tubes 59 are provided on the external pumps 71 connected to the main ink tanks 2, each of which serves as an ink supply source. Liquid connectors (not illustrated) are provided at leading ends of the ink supply tubes 59. When the liquid ejection head 1 is mounted on the liquid ejection device 50, the liquid connectors provided at the leading ends of the ink supply tubes 59 are liquid-tightly connected to liquid connector insertion ports, which are liquid inlet ports provided on a head housing of the liquid ejection head 1. Thereby, an ink supply path is formed to range from the ink tank 2 through the external pump 71 to the liquid ejection head 1. In the first embodiment, the four types of inks are used. Thus, a total of four sets of ink tanks 2, external pumps 71, ink supply tubes 59, and sub-ink tanks 54 are provided corresponding to the four types of inks. Four ink supply paths corresponding to the respective inks are independently formed in the liquid ejection device 50.

As described above, the liquid ejection device 50 is provided with an ink supply system to which the inks are supplied from the ink tanks 2 provided outside the liquid ejection head 1. Note that the liquid ejection device 50 is not provided with an ink collecting system that collects the ink in the liquid ejection head 1 to the ink tanks 2. Therefore, the liquid ejection head 1 is provided with the liquid connector insertion ports for connecting the ink supply tubes 59 of the ink tanks 2, but is not provided with connector insertion ports for connecting tubes for collecting the inks in the liquid ejection head 1 to the ink tanks 2. Note that the liquid connector insertion port is provided for each ink.

FIGS. 3B, 3C, and 3D are diagrams illustrating examples of configurations of the liquid ejection chips 3 that constitute the liquid ejection head 1. FIG. 3B shows an example of a configuration of one chip for four colors of inks. FIG. 3C shows an example of a configuration of one chip for two colors of inks. FIG. 3D shows an example of a configuration of one chip for one color of ink. Each liquid ejection chip 3 is provided with an ejection port 11 and a pad used for electrical mounting. FIG. 3A shows a chip configuration of FIG. 3B.

FIG. 3B shows an example in which one liquid ejection chip 3 is provided corresponding to four colors of inks and the liquid ejection head 1 is provided with one liquid ejection chip 3. The four colors are, for example, black, cyan, magenta, and yellow. The liquid ejection chip 3 is provided with ejection port rows in which a plurality of ejection ports 11 are configured to be arranged at equal intervals in the Y direction and which correspond to the respective colors. In the present example, two ejection port rows disposed to be shifted in the X direction are each provided corresponding to each color. Note that the number of ejection port rows corresponding to each color does not have to be two, but may be only one. Further, two ejection port rows corresponding to only black may be provided, and a total of five ejection port rows may be provided for the four colors.

FIG. 3C shows an example in which one liquid ejection chip 3 is provided corresponding to two colors of inks and the liquid ejection head 1 is provided with two liquid ejection chips 3. When two chips are mounted on the liquid ejection head 1, two chips may be mounted on one liquid ejection head 1, or two liquid ejection heads may be provided such that each one chip is mounted on each one liquid ejection head 1.

FIG. 3D shows an example in which one liquid ejection chip 3 is provided corresponding to one color of inks and the liquid ejection head 1 is provided with four liquid ejection chips 3. In the present example, as in the example of FIG. 3C, four chips may be mounted on one liquid ejection head, or four liquid ejection heads each having one chip mounted thereon may be provided.

Further, as illustrated in FIGS. 3C and 3D, when the chip is divided into a plurality of chips, all the chips do not have to have the same chip length. Furthermore, various combinations for a different number of colors for the chips can be made, and the same applies when the total number of colors is greater than four.

### Liquid Ejection Chip

A configuration of the liquid ejection chip 3, especially constituent elements of a circulation unit, will be described in more detail. First, two basic configurations such as “straight type” and “U-shape type” will be described as configuration examples of the individual flow passages in the liquid ejection chip 3. The individual flow passage is a flow passage in which the first energy generating element (ejection energy generating element) and the second energy generating element (flow energy generating element) are disposed corresponding to each other and which is for sending ink to the ejection port 11.

### Straight Type

In the present specification, the “straight type” individual flow passage means a straight shape that extends in a direction intersecting with the ejection port row such that both end portions of the individual flow passage are located on both sides of the ejection port row interposed therebetween. In other words, in the individual flow passage of the individual ejection unit, the first energy generating element and the second energy generating element are arranged in a direction intersecting with the ejection port row.

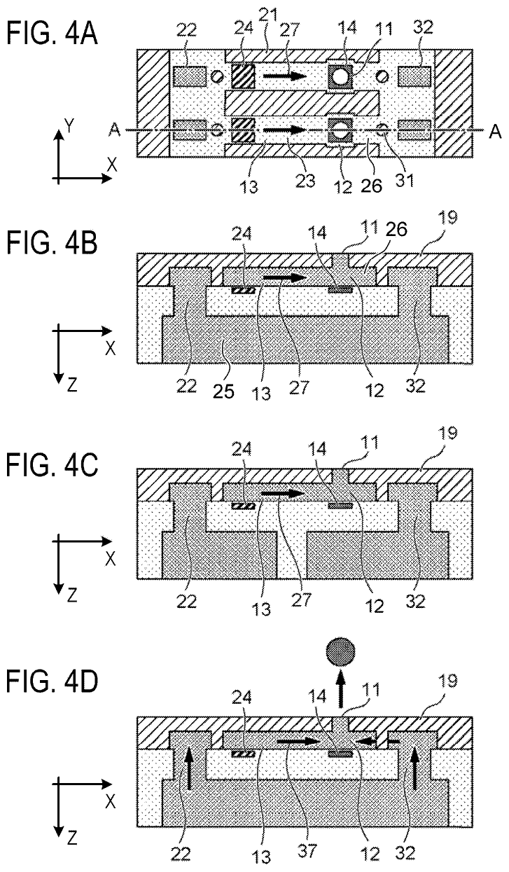

FIGS. 4A to 4D are explanatory diagrams of a straight type flow passage configuration. FIG. 4A is an explanatory diagram of a configuration of the vicinity of the ejection port 11 of the liquid ejection chip 3. FIG. 4A is a schematic diagram illustrating a positional relationship of main constituent elements when the liquid ejection chip 3 is viewed in the Z direction. The Z direction is substantially parallel to a direction in which the liquid is ejected from the ejection port 11. FIG. 4B is a cross-sectional view taken along the line A-A in FIG. 4A. FIG. 4C is a diagram illustrating a configuration example different from the example illustrated in FIG. 4B. FIG. 4C is a cross-sectional view taken along the line A-A in FIG. 4A. FIG. 4D is a diagram illustrating a flow of ink when the first energy generating element 14 is driven. In FIG. 4A, in order to show a positional relationship of the main constituent elements, the first energy generating element 14 and the second energy generating element 24 are hatched in the same manner as in FIG. 4B, and the ejection ports 11 are indicated by solid lines.

The liquid ejection chip 3 has a substrate 18 in which the ejection ports 11 are formed, and an orifice plate 19 connected to the substrate 18 and having a flow passage formed therein, and is a flow passage forming portion in which a flow passage through which ink flows is formed. The ink supplied from the ink tank 54 is ejected from the ejection port 11 through the flow passage formed in the substrate 18. A meniscus of the ink is stretched over the ejection port 11, and an ejection port interface is formed as an interface between the ink and the atmosphere.

Between the substrate 18 and the orifice plate 19, pressure chambers 12 are partitioned by partition walls 21 and are each provided corresponding to each ejection port 11, and the individual flow passages 23 for flowing ink through the pressure chambers 12 are formed. In the configuration example illustrated in FIG. 4A, the pressure chambers 12 and the individual flow passages 23 are formed respectively corresponding to the plurality of ejection ports 11. FIG. 4A shows the individual flow passages 23 each of which formed in a straight line shape ranging from a position corresponding to the first energy generating element 14 to a position corresponding to the second energy generating element 24. In the present example, the extending direction (X direction) of the individual flow passages 23 is perpendicular to a direction (Y direction) in which the ejection ports 11 are arranged in a row.

In the liquid ejection chip 3, a first opening 22 communicating with one end of the individual flow passage 23 and a second opening 32 communicating with the other end of the individual flow passage 23 are formed. In the first embodiment, one first opening 22 and one second opening 32 are provided for each individual flow passage 23. That is, in the X direction, the first opening 22 is located on one side with respect to the individual flow passage 23, and the second opening 32 is located on the other side with respect to the individual flow passage 23. Further, in the liquid ejection chip 3, a common flow passage 25 communicating with the plurality of first openings 22 and the plurality of second openings 32 is formed.

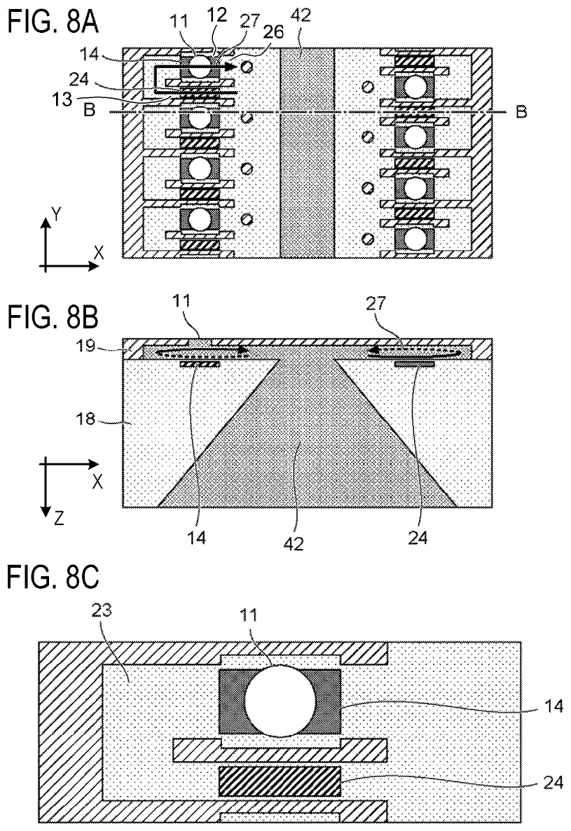

In the configuration example of FIG. 4A, a plurality of independent openings such as the first opening 22 and the second opening 32 are provided as openings for supplying liquid from the common flow passage 25 to the individual flow passages 23, but the present disclosure is not limited to such a configuration. For example, as illustrated in FIG. 8A to be described later, a configuration, in which a supply groove is provided as one large opening, may be provided.

The substrate 18 is provided with a first energy generating element 14 that generates energy for ejecting ink in the pressure chamber. The first energy generating element 14 is provided at a position overlapping with the ejection port 11 and the pressure chamber 12 of the individual flow passage 23 as viewed in the Z direction. Further, the first energy generating element 14 is located closer to the second opening 32 than the first opening 22, together with the ejection port 11 and the pressure chamber 12. The first energy generating element 14 is driven to generate heat to foam the ink in the pressure chamber 12, and the ink can be ejected from the ejection port 11 by using the foam energy.

In the first embodiment, an electro-thermal conversion element is used as the first energy generating element 14. However, the first energy generating element 14 is not limited to the electro-thermal conversion element, and a piezoelectric element or the like may be used.

The substrate 18 is further provided with the second energy generating element 24 that generates energy for generating a circulation flow 27 which is a flow of the ink in the individual flow passage. The second energy generating element 24 is located closer to the first opening 22 than the second opening 32. As indicated by the arrows in FIG. 4A, the circulation flow 27 is a direction from the second energy generating element 24 toward the first energy generating element 14, and is substantially parallel to the X direction.

In the first embodiment, an electro-thermal conversion element is used as the second energy generating element 24.

The individual flow passages 23 extend in a second direction (X direction) that intersects (perpendicular in the present example) with a first direction (Y direction) in which the ejection ports 11 are arranged in a row. The individual flow passages 23 include the pressure chamber 12, an inlet (upstream) side connection flow passage 13 communicating with one end portion of the pressure chamber 12, and an outlet (downstream) side connection flow passage 26 communicating with the other end portion of the pressure chamber 12. In the following description, the terms “inlet (flow inlet)”, “outlet (flow outlet)”, “upstream”, and “downstream” of the individual flow passage 23 refer to positional relationships in the flow of ink during ink circulation when the second energy generating element 24 is driven.

The individual flow passage 23 communicates with a first opening 22 and a second opening 32 respectively penetrating through the substrate 18 at one end thereof on the upstream side and the other end thereof on the downstream side. Therefore, the connection flow passage 13 is located closer to the second energy generating element than the ejection port row. In other words, as viewed in the Z direction, the second energy generating element 24 is provided at a position overlapping with a portion of the connection flow passage 13 of the individual flow passage 23. Both end portions of the individual flow passage 23 are located on opposite sides of the ejection port row interposed therebetween in the X direction.

The ink flow in the individual flow passage 23 is roughly divided into the following two types: (1) a first ink flow for driving the first energy generating element 14 and refilling after ejection, and (2) a second ink flow for driving the second energy generating element 24 and forming the circulation flow 27.

When the first energy generating element 14 is driven and the ink (liquid) is ejected from the ejection port 11, the ink is supplied from the first opening 22 and the second opening 32 in accordance with the ejection. That is, the ink flows into the pressure chamber 12 from both openings (the first opening 22 and the second opening 32) through the individual flow passage 23. In FIG. 4D, the arrows indicate the flow of the ink when the first energy generating element 14 is driven and ink droplets (liquid droplets) are ejected from the ejection port 11. Such a flow is the first ink flow. In such a case, the first opening 22 and the second opening 32 each function as a supply opening for supplying ink to each individual flow passage 23.

When the second energy generating element 24 is driven to form the circulation flow 27, the ink flows into the individual flow passage 23 through the first opening 22 on the connection flow passage 13 side, and the ink flows out to the outside through the second opening 32 on the connection flow passage 26 side. In the present example, the ink, which flows out from the second opening 32, is returned to the first opening 22 and is circulated to form the circulation flow 27 in the individual flow passage 23. In such a case, the first opening 22 functions as a supply opening for supplying ink to the individual flow passage 23, and the second opening 32 functions as a collection opening for collecting the ink which flows out from the individual flow passage 23.

Note that FIG. 4B shows a configuration in which the first opening 22 and the second opening 32 are shared in the chip and communicate with the same common flow passage 25, but the present disclosure is not limited to such a configuration. For example, as illustrated in FIG. 4C, the first opening 22 and the second opening 32 may be configured to be connected to the individual flow passages and may be shared outside the recording head.

Filters 31 for removing foreign matter from the ink may be provided in the ink circulation flow passages inside and outside the liquid ejection head 1. In the example illustrated in FIG. 4A, the filters 31 are respectively disposed outside the individual flow passage 23, on the inflow side and outflow side of the individual flow passage 23. The filter 31 may also be disposed between the first energy generating element 14 and the second energy generating element 24 in the individual flow passage 23. In such a case, the filter 31 does not have to be disposed on the upstream side (second energy generating element side) which is the outer side of the individual flow passage 23.

### U-Shape Type

In the present specification, the “U-shape type” individual flow passage means a flow passage having a U-shape as viewed in the Z direction. That is, in the individual flow passage, the first energy generating element and the second energy generating element are disposed along the ejection port row. Further, the individual flow passage is configured such that both end portions thereof are located on a single side with respect to the ejection port row. In the following description of the U-shape type individual flow passage, the same reference numerals and signs are attached to the constituent elements similar to the constituent elements of the straight type individual flow passage illustrated in FIGS. 4A to 4D. Thus, the description thereof will not be repeated.

FIGS. 8A to 8D are explanatory diagrams of a U-shape type flow passage configuration. FIG. 8A is an explanatory diagram of the configuration of the vicinity of the ejection port 11 of the liquid ejection chip 3. FIG. 8A is a schematic diagram illustrating a positional relationship of the main constituent elements when the liquid ejection chip 3 is viewed in the Z direction. FIG. 8B is a cross-sectional view taken along the line B-B in FIG. 8A. FIG. 8C is an enlarged schematic diagram of the individual flow passage portion in FIG. 8A. In FIG. 8A, in order to show the positional relationship of the main constituent elements, the first energy generating element 14 and the second energy generating element 24 are hatched in the same manner as in FIG. 8B, and the ejection ports 11 are indicated by solid lines.

In the configuration example illustrated in FIG. 8A, two ejection port rows are shown, each row including a plurality of ejection ports 11 arranged in the Y direction. The individual flow passages 23 including the pressure chambers 12 are respectively formed corresponding to the plurality of ejection ports 11. Further, a supply groove 42, which is longitudinal in the Y direction and opens in the Z direction between the two ejection port rows, is formed on the substrate 18.

The first energy generating element 14 and the second energy generating element 24 are both located near the supply groove 42, and are provided at positions overlapping with the individual flow passage 23 as viewed in the Z direction. The first energy generating element 14 and the second energy generating element 24 are arranged in a row in the first direction (Y direction) in which the ejection ports 11 are arranged. In the entire liquid ejection chip, a plurality of first energy generating elements 14 and a plurality of second energy generating elements 24 are alternately arranged in the first direction. The individual flow passage 23 is formed in a bent U-shape such that an end portion of the flow passage corresponding to the first energy generating element 14 is connected to an end portion of the flow passage corresponding to the second energy generating element 24.

The individual flow passages 23 include the pressure chamber 12, the inlet (upstream) side connection flow passage 13 communicating with one end portion of the pressure chamber 12, and the outlet (downstream) side connection flow passage 26 communicating with the other end portion of the pressure chamber 12. The connection flow passage 13 is a flow passage that overlaps with the second energy generating element 24 as viewed in the Z direction. The individual flow passages 23 communicate with the supply groove 42 that penetrates the substrate 18 in both the upstream side connection flow passage 13 and the downstream side connection flow passage 26. Both end portions of the individual flow passage 23 open toward the supply groove 42 in the X direction and are located adjacent to a single side with respect to the supply groove 42 in the Y direction.

The ink flows in the individual flow passages 23 of the U-shape type are classified into two types, (1) the first ink flow and (2) the second ink flow, as in the straight type.

When the first energy generating element 14 is driven and liquid is ejected from the ejection port 11, ink is supplied from the supply groove 42 in accordance with the ejection, and the ink flows into the pressure chamber 12 from both the connection flow passage 13 and the connection flow passage 26. Such a flow is the first ink flow.

When the second energy generating element 24 is driven and the circulation flow 27 is formed, in the individual flow passages 23, liquid flows into the inlet (upstream) side connection flow passage 13 and flows out to the outlet (downstream) side connection flow passage 26. In the present example, the flow into and out of the common supply groove 42 creates the circulation flow 27 in the individual flow passages 23 as indicated by the arrows in FIGS. 4A and 4B. Such a flow is the second ink flow.

In the configuration example of FIG. 8A, the supply groove 42 is provided as an opening for supplying liquid to the individual flow passage 23, but the present disclosure is not limited to such a configuration. For example, instead of the supply groove 42, a plurality of openings arranged in the first direction (Y direction) as illustrated in FIG. 4A may be provided. When the supply groove 42 is replaced with the plurality of openings, the openings are configured to be shared within the chip as in FIG. 4B.

### Pump Principle

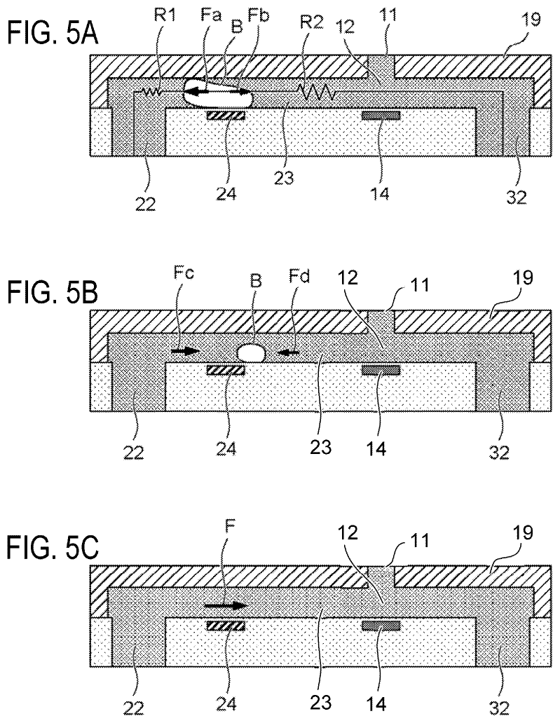

Next, description will be given of the principle of generation of the circulation flow of ink by driving the second energy generating element 24 which is an electro-thermal conversion element. The principle of the generation of the circulation flow will be described using the straight type individual flow passage 23 illustrated in FIGS. 4A and 4B as an example. FIGS. 5A to 5C are explanatory diagrams of the principle of the generation of the circulation flow of ink, showing a cross-section taken along the line A-A in FIG. 4A. FIGS. 5A to 5C show a process of generation and growth of bubble B, a process of shrinkage of the bubble B, and a process after collapse of the bubble B. The bubble B is caused by boiling of ink film when the second energy generating element 24 as a circulation heater heats the ink.

FIG. 5A shows the process of generation and growth of the bubble B. The second energy generating element 24 is located closer to the first opening 22 than the second opening 32. Therefore, a flow resistance R1 between the second energy generating element 24 and the first opening 22 is less than a flow resistance R2 between the second energy generating element 24 and the second opening 32. FIG. 5A is combined with an equivalent circuit that expresses such flow resistances R1 and R2 as electrical resistances. The bubble B caused by boiling of ink film grows biased toward the first opening 22 side, which is a supply flow passage with a smaller flow resistance R1, due to the difference between the flow resistances R1 and R2, as illustrated in FIG. 5A. Consequently, in the individual flow passage 23, an ink flow Fa toward the first opening 22 is greater than an ink flow Fb toward the second opening 32.

FIG. 5B is a diagram illustrating the process of shrinkage of the bubble B. During the process of shrinkage of the bubble B, the ink flows in to compensate for a volume of the shrinkage. In such a case, as illustrated in FIG. 5B, an ink flow Fc flowing in from the first opening 22 on a side having the smaller flow resistance R1 is greater than an ink flow Fd flowing in from the second opening 32 on a side having the larger flow resistance R2. Further, a position where the bubble B collapses shifts from above the second energy generating element 24 (circulation heater) toward the second opening 32.

FIG. 5C is a diagram illustrating the process after collapse of the bubble B. Due to a relationship Fc>Fd in the flow of ink generated during the process of shrinkage of the bubble B in FIG. 5B, a circulation flow F of ink from the first opening 22 toward the second opening 32 is generated. Thus, the circulation flow F is generated to flow from the first opening 22 side to the second opening 32 side, that is, from the second energy generating element 24 side to the first energy generating element 14 side.

A magnitude of such a circulation flow F depends on a ratio of flow resistances R1 and R2 and a size of the air bubble B. For example, the following case may be considered as a premise: a circulation heater, which is an electro-thermal conversion element, is used as the second energy generating element 24. In such a case, in order to increase the circulation flow F, it is preferable that the second energy generating element 24 is located closer to one of both end portions of the individual flow passage 23 than the first energy generating element 14. In other words, it is preferable to make a distance from the second energy generating element 24 to one end of the individual flow passage 23 shorter than a distance from the first energy generating element 14 to the other end of the individual flow passage 23. Specifically, it is preferable to set a flow resistance ratio R1/R2 in a range of 0.05 to 0.40. By setting the flow resistance ratio R1/R2 in the range, the circulation flow F can be maximized.

It is desirable that the circulation flow F increases the ink flow Fa toward the first opening 22 illustrated in FIGS. 5A and 5B and increases the ink flow Fc flowing in from the first opening 22. Therefore, it is effective to reduce the flow resistance R1. Further, it is desirable to make the ink flow Fb toward the outflow flow passage 15 as small as possible and to reduce the ink flow Fd flowing in from the second opening 32. Therefore, it is effective to increase the flow resistance R2. Considering the above description, it is desirable to reduce the flow resistance R1 and increase the flow resistance R2, that is, to reduce the flow resistance ratio R1/R2. Further, a large bubble B, that is, a large bubble volume, leads to an increase in the volume of space excluding the fluid generated from the individual flow passage 23, and therefore increases the circulation flow F. Means for increasing the bubble volume includes:
increasing a size of the second energy generating element 24 (circulation heater);
reducing the flow resistance by increasing a width and a height of the individual flow passage 23;
reducing an ink viscosity;
increasing a head temperature;
making driving pulses as double pulses;
and the like.

Since a part of the circulation flow F of ink enters the ejection port 11, the concentrated ink in the ejection port 11 is sent to the second opening 32 side, and fresh ink flows into the ejection port 11 from the first opening 22 side through the connection flow passage 13. In such a manner, by making the concentrated ink less likely to remain in the ejection port 11, the concentrated ink can be prevented from having the effect. As a result, the initial ink ejection state can be maintained.

The circulation flow F is a transient flow that accompanies the process of growth and the process of shrinkage when the bubble B is generated. Therefore, the inertial flow of the bubble B after collapse attenuates over time and stops after a certain time period. Accordingly, in order to steadily generate the circulation flow F for a certain time period, it is necessary to repeatedly drive the second energy generating element 24, which is a circulation heater.

The driving cycle of the second energy generating element 24 is not particularly limited as long as the concentrated ink in the ejection port 11 can be discharged. Here, due to the transient flow that accompanies the process of growth and the process of shrinkage when the bubble B is generated, the effect is reduced when the driving is performed at a high driving frequency such as 100 kHz, in consideration of the cycle of 10 μs, which is the time from the generation of the bubble to its collapse. Accordingly, it is preferable to drive the second energy generating element 24 at a period of, for example, about 100 Hz to several tens of kHz. Thus, the higher the driving frequency, the more the circulation flow F is stably maintained, and the greater the effect of discharging the concentrated ink. On the other hand, it is necessary to consider the rise in temperature of the ink due to the heat generated by the driving of the second energy generating element 24. Therefore, it is necessary to drive the second energy generating element 24 an appropriate number of times.

### Recirculation Concentration

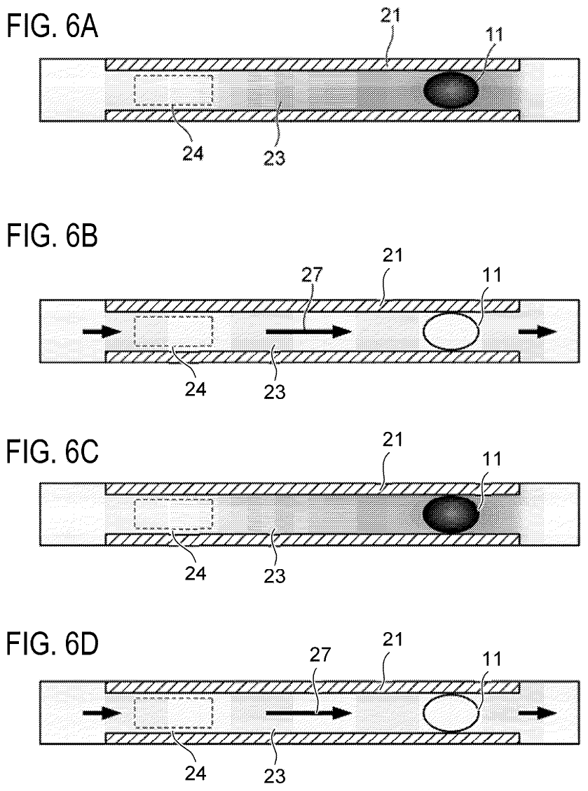

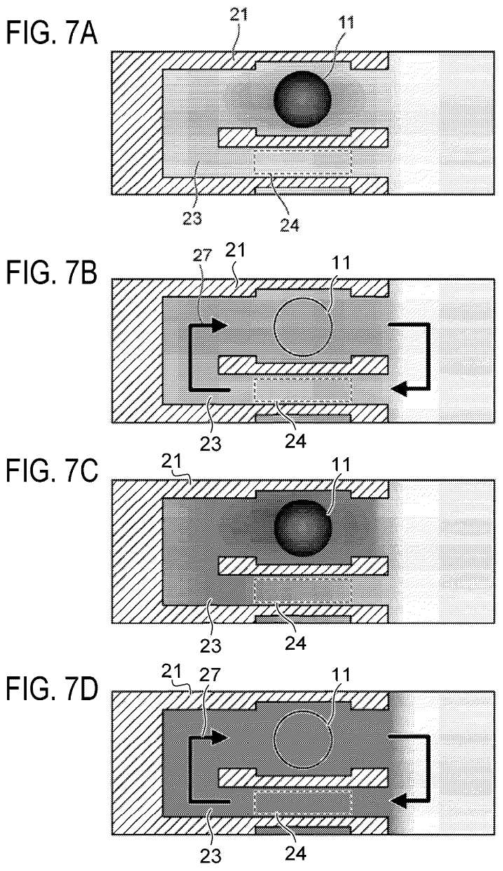

Next, the elimination of ink concentration in the individual flow passage 23 through ink circulation will be described in more detail. FIGS. 6A to 6D are explanatory diagrams of the states of concentration of ink in a straight type where the inlet and outlet of the circulation flow in the individual flow passage 23 are separated. FIGS. 7A to 7D are explanatory diagrams of the states of concentration of ink in a U-shape type where the inlet and outlet of the circulation flow in the individual flow passage 23 are adjacent. In FIGS. 6A to 6D and FIGS. 7A to 7D, a part where the ink is concentrated is shown in a dark color, and the degree of concentration is indicated by the shade.

FIG. 6A shows a state where the circulation flow 27 of the ink is temporarily stopped in the straight type individual flow passage 23. When the circulation flow 27 is temporarily stopped and ink does not flow, the volatile components of the ink evaporate from the ejection port portion, and the ink is concentrated in the vicinity of the ejection port.

FIG. 6B shows a state immediately after the second energy generating element 24 is driven to generate the circulation flow 27 from the state of FIG. 6A. The circulation flow 27 eliminates the concentration in the vicinity of the ejection port. The ink concentrated in the vicinity of the ejection port is discharged from the outlet of the individual flow passage 23, and the concentration is eliminated in the entire individual flow passage.

FIG. 6C shows a state where the circulation flow 27 of the ink is further temporarily stopped from the state of FIG. 6B. By temporarily stopping the circulation flow 27 of the ink, the ink is concentrated again in the vicinity of the ejection port, and a state of the ink becomes similar to the state illustrated in FIG. 6A.

FIG. 6D shows a state immediately after the second energy generating element 24 is driven to generate the circulation flow 27 from the state of FIG. 6C. The circulation flow 27 eliminates the concentration in the vicinity of the ejection port again, as in the state illustrated in FIG. 6B, and also eliminates the concentration in the entire individual flow passage. As described above, in a straight type where the inlet and outlet of the individual flow passage 23 are separated, the state of concentration is reset each time the temporary stop and circulation operations are repeated.

FIG. 7A shows a state where the circulation flow 27 of the ink is temporarily stopped in the U-shape type individual flow passage 23. When the circulation flow 27 is temporarily stopped and ink does not flow, the volatile components of the ink evaporate from the ejection port portion, and the ink is concentrated in the vicinity of the ejection port.

FIG. 7B shows a state immediately after the second energy generating element 24 is driven to generate the circulation flow 27 from the state of FIG. 7A. In the U-shape type individual flow passage 23, the inlet and outlet thereof are adjacent to each other and are close to each other. Therefore, the ink concentrated in the vicinity of the ejection port is discharged from the outlet of the individual flow passage 23, but flows back in from the inlet. Thereby, the entire individual flow passage is replaced with slightly concentrated ink instead of fresh ink. In the following description, such a phenomenon is referred to as recirculation concentration.

FIG. 7C shows a state where the circulation flow 27 of the ink is further temporarily stopped from the state of FIG. 7B. By temporarily stopping the circulation flow 27 of the ink, the ink is concentrated again in the vicinity of the ejection port. In such a case, the ink in the individual flow passage 23 is more concentrated than in the state illustrated in FIG. 7A.

FIG. 7D shows a state immediately after the second energy generating element 24 is driven to generate the circulation flow 27 from the state of FIG. 7C. In such a case, due to the effect of recirculation concentration, the entire individual flow passage is replaced with more concentrated ink than in the state illustrated in FIG. 7B.

As described above, in the U-shape type individual flow passage 23 in which the inlet and outlet are adjacent, the state of concentration is not reset each time the temporary stop and circulation operations are repeated, and the concentration gradually progresses throughout the individual flow passage, causing the state of concentration to deteriorate. Further, even when the circulation operation is not repeated, the ink may be highly concentrated in the vicinity of the ejection port due to a long stop time period or the like. In such a case, the state of concentration is unlikely to improve even in the first circulation operation. The reason for this is that the state of concentration is less improved in the recirculation concentration.

Therefore, in terms of the state of concentration elimination due to the temporary stop and circulation operations due to the difference in the effect of the discharged concentrated ink, there is a difference between the straight type in which the inlet and outlet of the individual flow passage 23 are separated and the U-shape type in which the inlet and outlet of the individual flow passage 23 are adjacent. In the straight type, the state of concentration is easily eliminated throughout the entire individual flow passage. Thus, the ejection stability is less likely to decrease due to concentrated ink. In contrast, in the U-shape type, the state of concentration is not easily eliminated throughout the entire individual flow passage in the recirculation concentration. Thus, the ejection is likely to become unstable due to the concentration of the entire individual flow passage.

### Ink

As described above, although the degree of concentration elimination differs in accordance with the difference in the flow passage configuration, the effect of the concentrated ink evaporated and thickened at the ejection port 11 can be suppressed by generating the ink circulation flow in the individual flow passage using the second energy generating element 24. In other words, the ink ejection state can be satisfactorily maintained by driving the second energy generating element 24. Thus, the effects of changes in ejection speed and the like can be reduced, and the ejection is easily stabilized.

Meanwhile, it is assumed that the use of inks having different types of coloring materials and different solid content is used in accordance with the use of the liquid ejection head 1 and the liquid ejection device 50 on which the liquid ejection head 1 is mounted. That is, it is preferable for the performance of the liquid ejection head 1 to be able to maintain a high level of ejection stability regardless of the type of ink used. For example, it is considerable to use ink with a reduced water content to address issues, which may be caused by the water in the ink, such as curling (warping) and cockling (wavy wrinkles) on plain paper. Ink with a low water content has a high concentration of solids such as organic solvents, pigments, and resins other than water. Thus, a rapid increase in viscosity is likely to occur as the water evaporates, which is likely to lead to a decrease in ejection stability of the ink. For such inks, a method of generating a circulation flow in a pressure chamber is effective because the method is able to suppress the increase in viscosity of the ink. Generally, an ink with a high solid content indicates a solid content of 10 wt %. That is, the present disclosure is suitable for application to inks with a solid content of 10 wt % (mass %) or more.

Further, the temperature at which the liquid ejection head 1 operates may be heated to a constant temperature by causing heaters disposed over the entire liquid ejection chip 3 to control the heat. Since the ink viscosity changes depending on the temperature, the ink viscosity at the head operation temperature affects the ejection stability.

When the circulation flow using the second energy generating element 24 is formed, the instantaneous flow speed of the circulation flow can be several tens of mm/s to 1000 mm/s. The average flow speed as viewed over a time span of the order of several hundreds of microseconds depends on the driving frequency of the circulation heater. The reason for this is that the circulation heater is a transient circulation flow that attenuates over time and stops after a certain time period. When the second energy generating element 24 is driven at about 10 to 20 kHz, which is the same as the driving frequency (ejection frequency) of the first energy generating element 14, an average flow speed can be several mm/s to 100 mm/s.

When ink with a high pigment concentration, for example, ink with a viscosity of at least 3 cP and not more than 6 cP at the head operation temperature, is used, the viscosity of the ink tends to increase at the ejection port portion in accordance with the non-ejection time period (stop time period). Therefore, a change in ejection speed tends to occur, and the ejection stability tends to decrease. When using such ink, it is necessary to circulate the ink during a short stop time period, and it is necessary to eliminate the concentration by performing steady ink circulation or transient ink circulation at a high frequency. When the circulation heater is used as the second energy generating element 24, the ink circulation is transient. Therefore, the circulation operation can be performed at a high frequency to contribute to eliminating the concentration at the ejection port portion.

In contrast, when ink with a low pigment concentration, for example, ink with a viscosity of at least 1 cP and not more than 2 cP at the head operation temperature, is used, the ejection speed may change depending on the non-ejection time period (stop time period). Here, the effect is relatively small compared to the effect of high-concentration ink. As the stop time period increases, the viscosity of ink increases at the ejection port portion in accordance with the non-printing drive time period (shutoff time period). Therefore, in order to restart printing after not printing and stopping for a certain time period, it is necessary to perform recovery processing associated with waste ink, such as a suction operation, a wiping operation, and preliminary ejection combined therewith. When the circulation heater is used as the second energy generating element 24, the circulation flow 27 is formed to contribute the elimination of concentration at the ejection port portion without generating waste ink through the recovery operation. Depending on the shutoff time period, it is also possible to prevent waste ink from being generated through the recovery processing using only the circulation operation. Alternatively, it is also possible to perform the recovery processing of minimizing an amount of waste ink as much as possible by partially combining a suction operation for removal of air bubbles inside the liquid ejection head 1, which is separate from the concentration elimination, while performing the recovery by performing the circulation operation.

In both high-concentration ink and low-concentration ink, it is desirable to return the ink to an initial fresh state thereof as much as possible in order to suppress the effects of concentrated ink. Therefore, even when the circulation heater is used as the second energy generating element 24, the lower the effect of the recirculation concentration, the better the circulation effect can be obtained. Consequently, the straight type configuration has a higher effect of eliminating concentration by circulating ink using the individual flow passages 23 than the U-shape type configuration.

### Method of Driving Liquid Ejection Head

Next, the method of driving the liquid ejection head 1 according to the first embodiment will be described in more detail. Hereinafter, the method of driving the liquid ejection head 1 will be described with reference to an exemplary case where the individual flow passages 23 in the first embodiment are U-shape type as illustrated in FIGS. 8A to 8C.

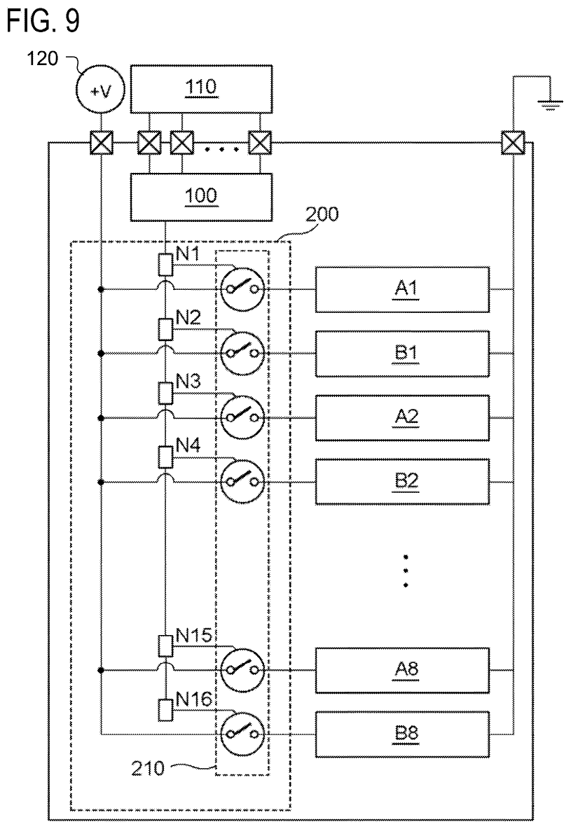

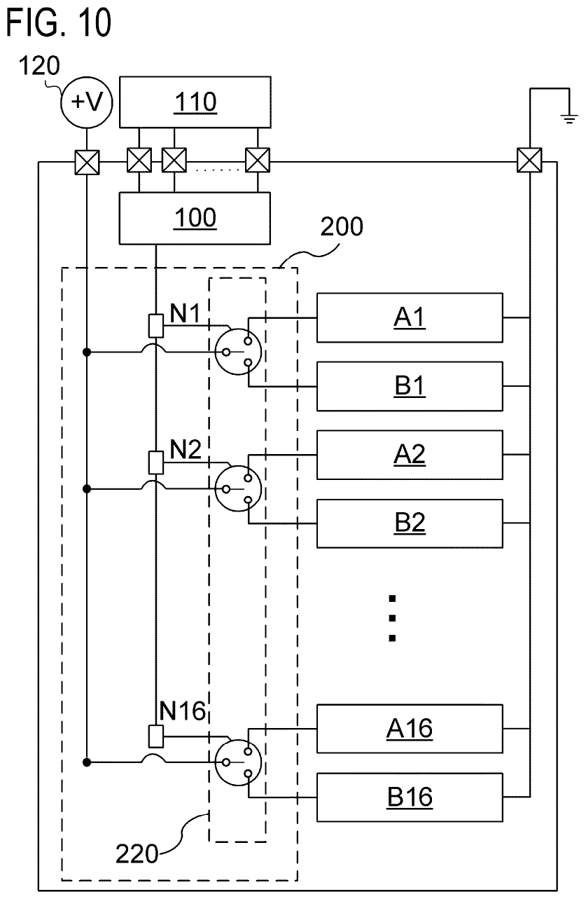

Hereinafter, prior to the description of the method of driving the liquid ejection head 1 according to the first embodiment, a method of driving the liquid ejection head 1 in a comparative configuration will be described. In description of the comparative configuration, the same constituent elements as those in the first embodiment will be represented by the same reference numerals and signs and the description thereof will not be repeated. FIG. 9 is a block diagram illustrating a configuration of the selection driving circuit 200 on the substrate 18 of the liquid ejection head 1 according to the comparative configuration. FIG. 10 is a block diagram illustrating a configuration of the selection driving circuit 200 on the substrate 18 in the first embodiment.

In the liquid ejection head 1, the first energy generating element 14 and the second energy generating element 24 are provided in each individual flow passage 23. In order to distinguish between the elements, the first energy generating element 14 is represented by Ai (i=1, 2, 3, . . . , n), and the second energy generating element 24 is represented by Bi (i=1, 2, 3, . . . , n). In such a case, for example, A1 and B1 are in the same individual flow passage. Further, when it is not necessary to particularly distinguish between the elements, the elements are simply referred to as the first energy generating element 14 and the second energy generating element 24. FIG. 9 shows a configuration example in which n=8 and eight first energy generating elements 14 and eight second energy generating elements 24 are provided. FIG. 10 shows a configuration example in which n=16 and sixteen first energy generating elements 14 and sixteen second energy generating elements 24 are provided.

### Driving Method in Comparative Configuration

In the comparative configuration, a selection driving circuit 200 as illustrated in FIG. 9 is formed on the substrate 18. The selection driving circuit 200 is a circuit for driving the first energy generating elements 14 and the second energy generating elements 24 on the basis of a control signal sent by the CPU 800 which is a control portion. Further, the liquid ejection head 1 includes a control data supply circuit 100, a voltage source 120 (+V), and a controller 110 provided outside the substrate 18. The voltage source 120 and the control data supply circuit 100 are each connected to the selection driving circuit 200, and the controller 110 is connected to the control data supply circuit 100.

The selection driving circuit 200 includes an on-off driving circuit 210. The on-off driving circuit 210 is an on-off switch that drives the first energy generating elements 14 (A1 to A8) and the second energy generating elements 24 (B1 to B8) on or off. The on-off driving circuit 210 drives each element on or off in response to a control signal at each address (N1 to N16 in the present example) received from the control data supply circuit 100. That is, the first energy generating element 14 and the second energy generating element 24 each are controlled independently by a switch that is configured to be capable of switching between a drivable state and a non-drivable state.

The control data supply circuit 100 controls a driving pulse for driving the first energy generating element 14 or the second energy generating element 24 and a time interval for applying the driving pulse to each element.

In the comparative configuration, the first energy generating elements 14 and the second energy generating elements 24 are associated with different addresses. Thus, it is necessary to provide separate driving circuits. For this reason, it is necessary to provide driving data for each of the first energy generating element 14 and the second energy generating element 24. Accordingly, the amount of data increases in accordance with the total number of elements including the first energy generating elements 14 and the second energy generating elements 24.

### Driving Method in First Embodiment

In the first embodiment, the selection driving circuit 200 as illustrated in FIG. 10 is formed on the substrate 18. The selection driving circuit 200 includes an on-off-on driving circuit 220, and is driven on the basis of the control signal sent from the CPU 800 which is the control portion. Thus, the first embodiment is different from the comparative configuration in that the selection driving circuit 200 includes the on-off-on driving circuit 220 instead of the on-off driving circuit 210 of the comparative configuration. Further, the voltage source 120 and the control data supply circuit 100 are each connected to the selection driving circuit 200, and the controller 110 is connected to the control data supply circuit 100. The configurations of the control data supply circuit 100, the voltage source 120, and the controller 110 are similar to the comparative configuration.

The on-off-on driving circuit 220 switches each element on-off in response to the control signal at each address (N1 to N16 in the present example) received from the control data supply circuit 100. In the first embodiment, the first energy generating element Ai and the second energy generating element Bi corresponding to the same individual flow passage 23 are associated with the same address. In the first embodiment, whether to drive the first energy generating element Ai or the second energy generating element Bi is determined on the basis of the driving data of the first energy generating element Ai based on the printing data. In the first embodiment, the first energy generating element Ai and the second energy generating element Bi are selectively controlled under the same time-division control.

The first energy generating element Ai and the second energy generating element Bi corresponding to the same individual flow passage 23 do not have to be driven simultaneously, and it is sufficient to drive either one of the elements. Therefore, in the first embodiment, the second energy generating element Bi is configured to be driven and controlled on the basis of the driving data (driving state) of the first energy generating element Ai. That is, the selection driving circuit 200 determines whether to drive the second energy generating element Bi depending on whether to drive the first energy generating element Ai.

As described above, in the first embodiment, the same address is designated to a set including the first energy generating element Ai and the second energy generating element Bi provided corresponding to the same individual flow passage 23. The selection driving circuit 200 is configured to select and drive only one of the first energy generating element Ai and the second energy generating element Bi, that is, not to drive the two elements simultaneously. In other words, the first energy generating element 14 and the second energy generating element 24 are selectively driven and controlled by the selection driving circuit 200. Therefore, the selection driving circuit 200 according to the first embodiment does not drive the second energy generating element Bi in a case where the first energy generating element Ai is driven, and drives the second energy generating element Bi in a case where the first energy generating element Ai is not driven.

The on-off-on driving circuit 220 may be configured to determine whether to drive neither the first energy generating element Ai nor the second energy generating element Bi (to turn both OFF). That is, the selection driving circuit 200 according to the first embodiment may be configured to determine whether to drive the first energy generating element Ai, the second energy generating element Bi, or neither in response to the single control signal (driving data).

With this configuration, it is not necessary to provide driving circuits with separate addresses for the first energy generating element Ai and the second energy generating element Bi, and it is not necessary to provide the driving data for the second energy generating element Bi. As a result, the amount of driving data can be reduced accordingly. Further, in a case of adopting a configuration in which a plurality of openings are provided instead of the supply groove 42, it is also possible to concentrate the circuits on a single side using inter-opening wirings for the wirings to the respective elements. As a result, it is possible to make the circuits more efficient.

As illustrated in FIG. 9, in the comparative configuration, a total of sixteen elements when n=8 are controlled as one group, which includes the first energy generating elements Ai and the second energy generating elements Bi for the sixteen addresses N1 to N16. On the other hand, as illustrated in FIG. 10, in the first embodiment, a total of 32 elements when n=16 are controlled as one group, which includes the first energy generating elements Ai and the second energy generating elements Bi for the same number of addresses N1 to N16. Therefore, in the first embodiment, the total number of elements in one group is double the total number of elements in the comparative configuration.

For comparison, measures against ink of which the viscosity is increased in the liquid ejection head that does not form a circulation flow will be described below. Examples of the measures include the preliminary ejection operation that ejects ink from the ejection port and the suction operation that sucks ink from the ejection port. For example, in a serial type liquid ejection device, the preliminary ejection operation or the suction operation is performed in a head standby region before moving away from a cap that protects the head and advancing to a printing operation. Alternatively, the preliminary ejection operation is performed in a non-printing region that is deviated from the print medium when the carriage moves back and forth for the printing operation. The operations are performed at different timings from the printing operation. Further, in the case of ink of which the viscosity tends to increase, the preliminary ejection operation may be performed in addition to the printing operation in the printing region during the reciprocating movement to an extent that does not affect the image on the printing medium.

In the first embodiment, the number of preliminary ejection operations and suction operations can be reduced by performing the circulation operation by driving the second energy generating element 24. When the circulation operation is performed in the head standby region or the non-printing region during the reciprocating movement, the circulation operation is also performed at a different timing from the printing operation. Therefore, in the first embodiment, both the first energy generating element 14 and the second energy generating element 24 can be driven by the single control signal (driving data) without providing dedicated driving data for the second energy generating element 24.

Further, in the case of ink of which the viscosity tends to increase, in the circulation operation in the printing region of the reciprocating movement, it is necessary to prioritize the timing of the ejection operation among the timings of operations close to the timing of the printing operation. On the other hand, by providing a plurality of timings for the circulation operation or providing a certain time period, it is not necessary to drive the circulation operation and the printing operation simultaneously. Therefore, in the first embodiment, when the first energy generating element side is selected, the first energy generating element 14 is driven, such that the circulation operation can be appropriately controlled without having an effect on the printing operation.

Note that, in the first embodiment, the first energy generating elements Ai and the second energy generating elements Bi which are a total of 32 elements (16 pairs) when n=16 are controlled as one group, but the present disclosure is not limited to such a configuration. For example, the total number of elements as one group may be set to various numbers such as 16 (8 pairs), 24 (12 pairs), and the like.

The second energy generating element 24 is not limited to an electro-thermal conversion element, and may be, for example, a piezoelectric element. When a piezoelectric element is used, the direction of the circulation flow may be reversed in accordance with the driving method, compared to the case of the electro-thermal conversion element.

### Second Embodiment

Next, a second embodiment according to the present disclosure will be described. The second embodiment is different from the first embodiment in the flow passage configuration of the liquid ejection head 1. Hereinafter, only the differences between the configuration of the second embodiment and the configuration of the first embodiment will be described. The same constituent elements in the configurations of the first and second embodiments are represented by the same reference numerals and signs, and the description thereof will not be repeated.

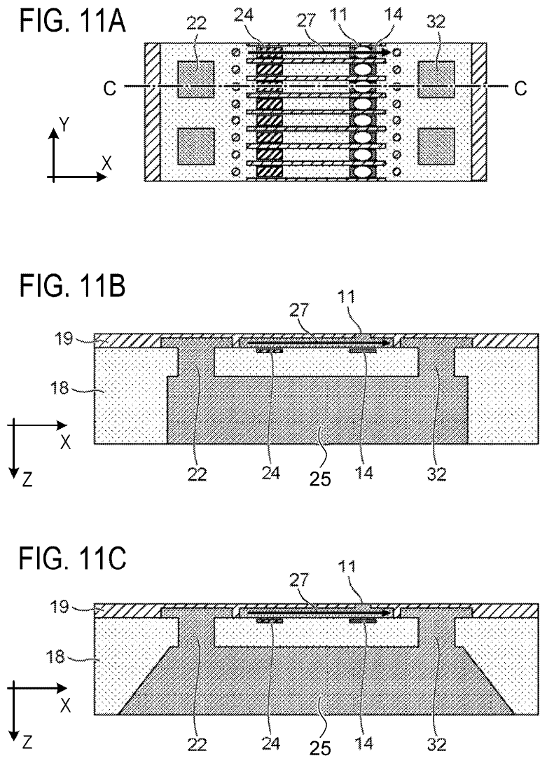

FIGS. 11A to 11C are explanatory diagrams of a flow passage configuration of the liquid ejection head 1 according to the second embodiment. FIG. 11A is an explanatory diagram of the configuration of the vicinity of the ejection port 11 of the liquid ejection chip 3. FIG. 11A is a schematic diagram illustrating a positional relationship of the main constituent elements when the liquid ejection chip 3 is viewed in the Z direction. FIG. 11B is a cross-sectional view taken along the line C-C in FIG. 11A. FIG. 11C is a view illustrating a configuration example different from the example illustrated in FIG. 11B. FIG. 11C is a cross-sectional view taken along the line C-C in FIG. 11A.

A shape of a rear side of the substrate 18 (a side opposite to a side to which the orifice plate 19 is bonded) can change in accordance with the type of etching method used for the substrate 18. FIGS. 11B and 11C show examples in which etching is performed by different methods to form the common flow passages 25 having different shapes. The common flow passage 25 may have an outer wall extending parallel to the Z direction as illustrated in FIG. 11B, or may have a shape in which a distance in the X direction between the partition walls increases with an increase in distance from the ejection port 11 as illustrated in FIG. 11C.

The individual flow passage 23 according to the second embodiment is different from that of the first embodiment in that the individual flow passage 23 is not a U-shape type but a straight type. That is, both ends of the individual flow passage 23 according to the second embodiment are disposed so as to be separated at positions opposite to each other with the ejection port row interposed therebetween, in the second direction (X direction) intersecting (perpendicular in the present example) with the first direction (Y direction) in which the plurality of ejection ports 11 are arranged. Further, the second embodiment is also different from the first embodiment in that the plurality of first openings 22 and the plurality of second openings 32 are provided instead of the supply groove 42 as flow passages for supplying ink to the individual flow passages 23.

Such a configuration has an advantage in that the flow inlet and flow outlet of the circulation flow are disposed separately to be separated from each other with the ejection port row interposed therebetween. Thus, ink concentrated at the ejection port portion due to circulation does not re-flow into the individual flow passages, thereby suppressing the concentration effect.

Further, a plurality of independent openings are provided. Therefore, it is possible to arrange the wiring to each element such that the wiring passes between the openings. In addition, it is also possible to concentrate the circuit on a single side. As a result, there is also an advantage of making the circuit more efficient.

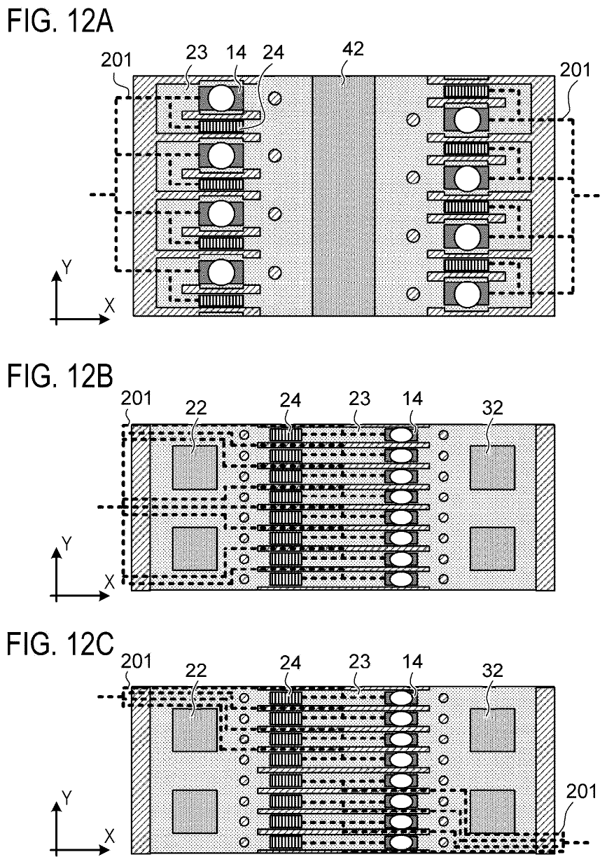

An arrangement of wirings 201 of the selection driving circuit 200 connected to the first energy generating elements 14 and the second energy generating elements 24 will be described with reference to examples. FIGS. 12A to 12C are diagrams illustrating an example of the arrangement of the wirings 201 of the selection driving circuit 200. The selection driving circuit 200 includes the plurality of wirings 201 to drive the plurality of first energy generating elements 14 and second energy generating elements 24.

FIG. 12A shows the arrangement of the wirings 201 of the liquid ejection chip 3 having the same configuration as the first embodiment (FIG. 8A). That is, the individual flow passages 23 of the configuration example are U-shape type, and the supply groove 42 is formed as an opening for supplying liquid to the individual flow passages 23. In addition, the ejection port row and the individual flow passages 23 corresponding to the ejection ports 11 are formed on each of one side and the other side with respect to the supply groove 42, in the X direction.

In the configuration example of FIG. 12A, the wirings 201 connected to the first energy generating elements 14 and the second energy generating elements 24 are disposed on the same side with respect to the supply groove 42 as the corresponding elements. That is, the selection driving circuits 200 are disposed on both sides of the supply groove 42 in the X direction.

FIG. 12B shows the arrangement of the wirings 201 of the liquid ejection chip 3 having the same configuration as the second embodiment (FIG. 11A). In other words, the individual flow passage 23 of the configuration example is a straight type extending in the X direction. The first openings 22 for supplying liquid to the individual flow passages 23 and the second openings 32 for supplying and repairing liquid to the individual flow passages 23 are formed therein. In the X direction, the first openings 22 are located on one side with respect to the individual flow passages 23, and the second openings 32 are located on the other side with respect to the individual flow passages 23.

In the configuration example of FIG. 12B, all the wirings 201 connected to the first energy generating elements 14 and the second energy generating elements 24 are disposed on the same one side with respect to the individual flow passages 23 as the first openings 22. Each of the wirings 201 is disposed to pass between the first openings 22 adjacent to each other in the Y direction. In other words, the selection driving circuits 200 are disposed on the one side with respect to the individual flow passages 23 in the X direction. By concentrating the selection driving circuits 200 on a single side in such a manner, the circuits can be made more efficient. Note that the wirings 201 may be disposed on the other side which is the same side as the second openings 32, and the selection driving circuits 200 may be disposed on the other side with respect to the individual flow passages 23.

FIG. 12C shows an arrangement of the wirings 201 of the liquid ejection chip 3 having the same configuration as the second embodiment (FIG. 11A), and shows an arrangement different from the configuration illustrated in FIG. 12B. In the configuration example of FIG. 12C, the wirings 201 connected to the first energy generating elements 14 and the second energy generating elements 24 disposed in some sections are disposed on one side with respect to the individual flow passages 23, which is the same side as the first openings 22. On the other hand, the wirings 201 connected to the first energy generating elements 14 and the second energy generating elements 24 disposed in another section are disposed on the other side with respect to the individual flow passages 23, which is the same side as the second openings 32. In such a manner, a configuration may be adopted in which one group of wirings 201 corresponding to a certain number of individual flow passages 23 is alternately arranged on one side and the other side with respect to the individual flow passages 23. Whether the wirings 201 are collected on a single side with respect to the individual flow passages 23 or disposed on both sides may be appropriately determined in consideration of the configurations of the liquid ejection head 1 and the liquid ejection chip 3.

### Third Embodiment

Next, a third embodiment according to the present disclosure will be described. The third embodiment is different from the first and second embodiments in the flow passage configuration of the liquid ejection head 1. Hereinafter, only the differences between the configuration of the third embodiment and the configuration of the second embodiment will be described. The same constituent elements in the configurations of the second and third embodiments are represented by the same reference numerals and signs, and the description thereof will not be repeated.

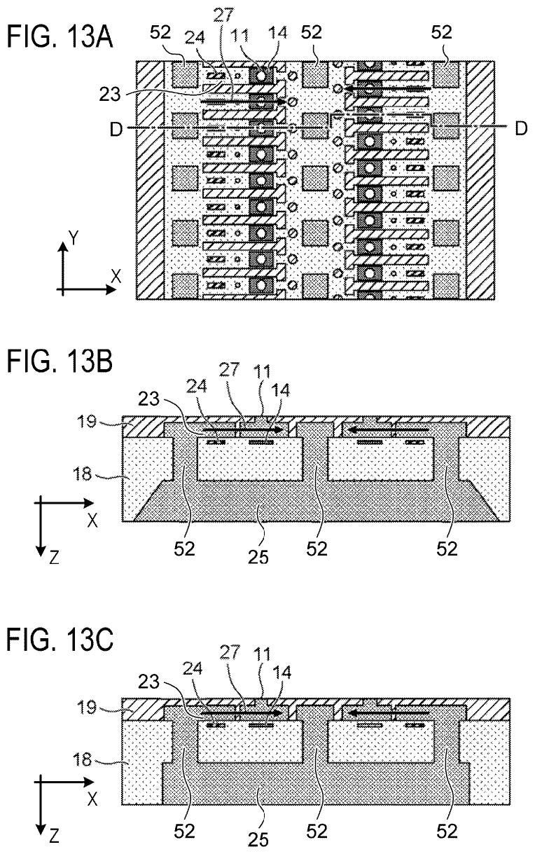

FIGS. 13A to 13C are explanatory diagrams of a flow passage configuration of the liquid ejection head 1 according to the third embodiment. FIG. 13A is an explanatory diagram of the configuration of the vicinity of the ejection port 11 of the liquid ejection chip 3. FIG. 13A is a schematic diagram illustrating a positional relationship of the main constituent elements when the liquid ejection chip 3 is viewed in the Z direction. FIG. 13B is a cross-sectional view taken along the line D-D in FIG. 13A. FIG. 13C is a view illustrating a configuration example different from the example illustrated in FIG. 13B. FIG. 13C is a cross-sectional view taken along the line D-D in FIG. 13A.

The third embodiment is different from the second embodiment in the number of ejection port rows and the number of opening rows. In the second embodiment, one ejection port row and two opening rows are provided, but in the third embodiment, two ejection port rows and three opening rows are provided. In the X direction, the opening rows and the ejection port rows are alternately arranged. Each individual flow passage 23 is formed corresponding to each ejection port 11, and each individual flow passage 23 is interposed between the opening rows in the X direction.

The substrate 18 is provided with the first energy generating elements 14 and the second energy generating elements 24 corresponding to the respective individual flow passages 23. For each individual flow passage 23, the ejection port 11 and the first energy generating element 14 are located closer to the center than the second energy generating element 24. That is, in the individual flow passage 23 located on the left side in FIG. 13A, the first energy generating element 14 is located on the right side with respect to the second energy generating element 24. Further, in the individual flow passage 23 located on the right side in FIG. 13A, the first energy generating element 14 is located on the left side with respect to the second energy generating element 24. That is, when the second energy generating element 24 is driven, the circulation flow 27 from the outer side toward the center in the X direction is generated in the individual flow passage 23.

The three opening rows are each configured with a plurality of openings 52 arranged in the Y direction. The three opening rows are configured such that positions of the openings 52 in the Y direction are mutually the same. When the circulation flow 27 is generated, the ink flows into the individual flow passages 23 from the openings 52 on the outer side in the X direction, and the ink which flows out of the individual flow passages 23 is collected in the openings 52 on the center side in the X direction.

Further, in the third embodiment, the ejection ports 11 constituting one ejection port row and the ejection ports 11 constituting the other ejection port row are disposed to be deviated from each other in the Y direction.

An advantage of such a configuration is that the number of ejection port rows can be doubled from one row to two rows by increasing the number of opening rows by one row from two rows to three rows. Further, one ejection port row and the other ejection port row can be disposed to be shifted in the Y direction. As a result, a degree of freedom in the arrangement of the ejection ports 11 is high. Furthermore, since it is not necessary to provide a wiring region between the openings of the central opening row in the X direction. As a result, degrees of freedom in the size and resolution of the openings in the central opening row are high. Thereby, another advantage thereof is that it is easy to achieve high productivity by rapidly refilling the nozzles.

In the third embodiment, all the openings constituting the three opening rows are disposed at the same position in the nozzle row direction (Y direction), but the present disclosure is not limited to such a configuration. For example, the openings may be disposed to be deviated in each row in accordance with the nozzle position or laying of the wiring between the openings. The same configuration may also be applied to the following embodiments.

### Fourth Embodiment

Next, a fourth embodiment according to the present disclosure will be described. The fourth embodiment is different from the third embodiment in the arrangement of the first energy generating elements 14 and the second energy generating elements 24. Hereinafter, only the differences between the configuration of the fourth embodiment and the configuration of the third embodiment will be described. The same constituent elements in the configurations of the third and fourth embodiments are represented by the same reference numerals and signs, and the description thereof will not be repeated.

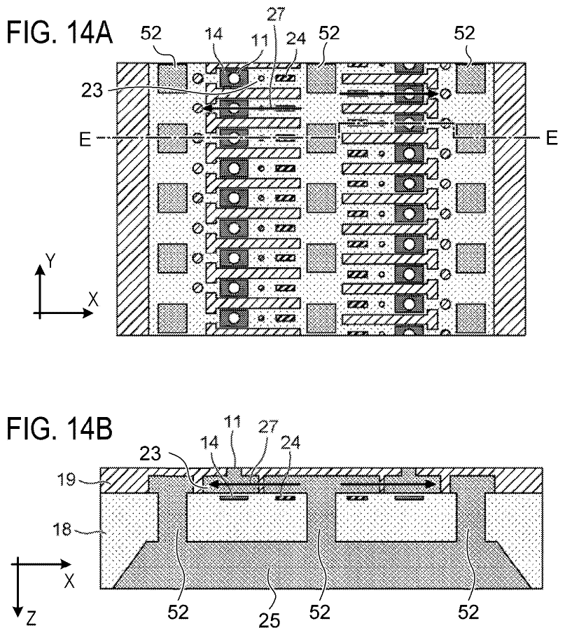

FIGS. 14A and 14B are explanatory diagrams of a flow passage configuration of the liquid ejection head 1 according to the fourth embodiment. FIG. 14A is an explanatory diagram of the configuration of the vicinity of the ejection port 11 of the liquid ejection chip 3. FIG. 14A is a schematic diagram illustrating a positional relationship of the main constituent elements when the liquid ejection chip 3 is viewed in the Z direction. FIG. 14B is a cross-sectional view taken along the line E-E in FIG. 14A.

In the fourth embodiment, arranged positions of the first energy generating elements 14 and the second energy generating elements 24 are reversed from the arranged positions in the third embodiment. That is, the second energy generating element 24 is located closer to the center in the X direction than the first energy generating element 14 and the ejection port 11. Accordingly, in the fourth embodiment, the direction of the circulation flow 27, which is generated when the second energy generating element 24 is driven, is a direction from the center side to the outer side in the X direction, which is opposite to the direction of the circulation flow 27 in the third embodiment.

An advantage of such a configuration is that the ink concentrated in the vicinity of the ejection port is branched off and discharged to the opening rows on both sides, suppressing the effect of the concentrated ink when the ink re-flows into the individual flow passages in accordance with ejection or the like. Further, another advantage is that the plurality of ejection port rows are disposed to be separated from each other, suppressing the effect of interference caused by meniscus vibration caused by ejection from each ejection port 11.

### Fifth Embodiment

Next, a fifth embodiment according to the present disclosure will be described. The fifth embodiment is different from the third embodiment in the arrangement of the first energy generating elements 14 and the second energy generating elements 24. Hereinafter, only the differences between the configuration of the fifth embodiment and the configuration of the third embodiment will be described. The same constituent elements in the configurations of the third and fifth embodiments are represented by the same reference numerals and signs, and the description thereof will not be repeated.

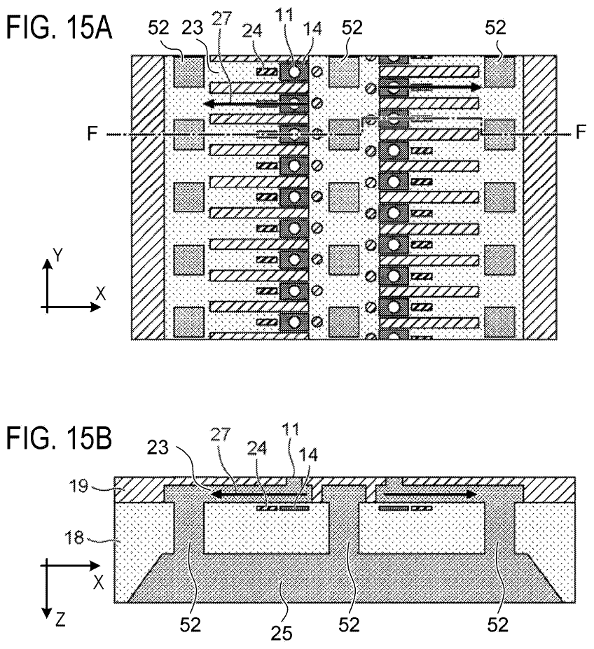

FIGS. 15A and 15B are explanatory diagrams of a flow passage configuration of the liquid ejection head 1 according to the fifth embodiment. FIG. 15A is an explanatory diagram of the configuration of the vicinity of the ejection port 11 of the liquid ejection chip 3. FIG. 15A is a schematic diagram illustrating a positional relationship of the main constituent elements when the liquid ejection chip 3 is viewed in the Z direction. FIG. 15B is a cross-sectional view taken along the line F-F in FIG. 15A.

The fifth embodiment is different from the third embodiment in that the second energy generating element 24 is closer to the first energy generating element 14. In the fifth embodiment, the second energy generating element 24 is disposed closer to the opening 52 on the center side than the opening 52 on the outer side in the X direction. With such a configuration, the direction of the circulation flow 27, which is generated when the second energy generating element 24 is driven, is a direction from the center side to the outer side in the X direction, which is opposite to the direction of the circulation flow 27 in the third embodiment.

An advantage of such a configuration is that, as in the third embodiment, there is a high degree of freedom in the size and resolution of the central opening row, making it easy to achieve high productivity by performing rapid refilling. Further, another advantage is that the ink concentrated in the vicinity of the ejection port is branched off and discharged to the opening rows on both sides, suppressing the effect of the concentrated ink when the ink re-flows into the individual flow passages in accordance with ejection or the like.

### Sixth Embodiment

Next, a sixth embodiment according to the present disclosure will be described. The sixth embodiment is different from the first embodiment in the flow passage configuration of the liquid ejection head 1. Hereinafter, only the differences between the configuration of the sixth embodiment and the configuration of the first embodiment will be described. The same constituent elements in the configurations of the first and sixth embodiments are represented by the same reference numerals and signs, and the description thereof will not be repeated.

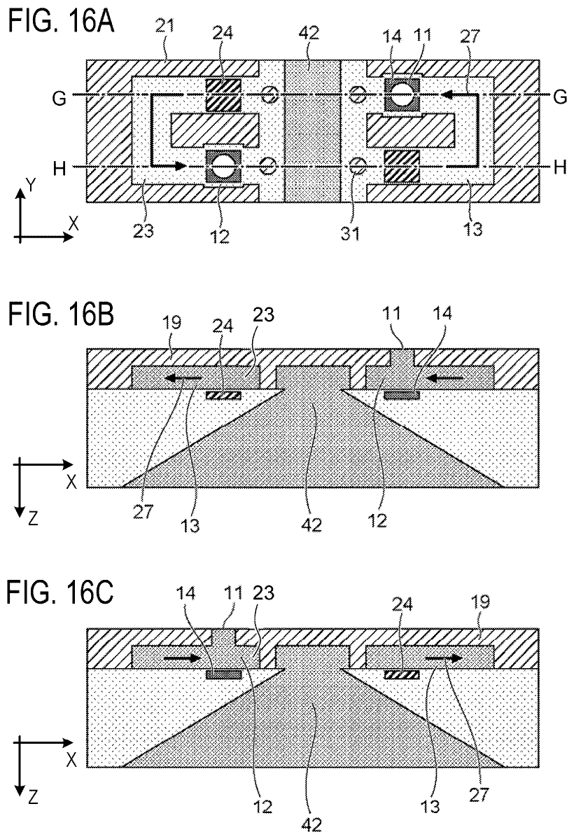

FIGS. 16A and 16B are explanatory diagrams of a flow passage configuration of the liquid ejection head 1 according to the sixth embodiment. FIG. 16A is an explanatory diagram of the configuration of the vicinity of the ejection port 11 of the liquid ejection chip 3. FIG. 16A is a schematic diagram illustrating a positional relationship of the main constituent elements when the liquid ejection chip 3 is viewed in the Z direction. FIG. 16B is a cross-sectional view taken along the line G-G in FIG. 16A. FIG. 16C is a cross-sectional view taken along the line H-H in FIG. 16A.

In the sixth embodiment, as in the first embodiment, there are two ejection port rows with the supply groove 42 interposed therebetween, and the individual flow passages 23 are U-shape type. The ejection ports 11 are disposed such that the ejection ports 11 constituting one ejection port row and the ejection ports 11 constituting the other ejection port row are arranged in a staggered manner in the Y direction.

Further, in the first embodiment, the filter 31 is disposed only at the outlet of the individual flow passage 23 (the end portion farther from the second energy generating element 24). In the sixth embodiment, the filter 31 is also disposed at the inlet of the individual flow passage 23 (the end portion closer to the second energy generating element 24).

With such a configuration, it is possible to obtain the same effects as the first embodiment.

### Seventh Embodiment

Next, a seventh embodiment according to the present disclosure will be described. The seventh embodiment is different from the second embodiment in the flow passage configuration of the liquid ejection head 1. Hereinafter, only the differences between the configuration of the seventh embodiment and the configuration of the second embodiment will be described. The same constituent elements in the configurations of the second and seventh embodiments are represented by the same reference numerals and signs, and the description thereof will not be repeated.

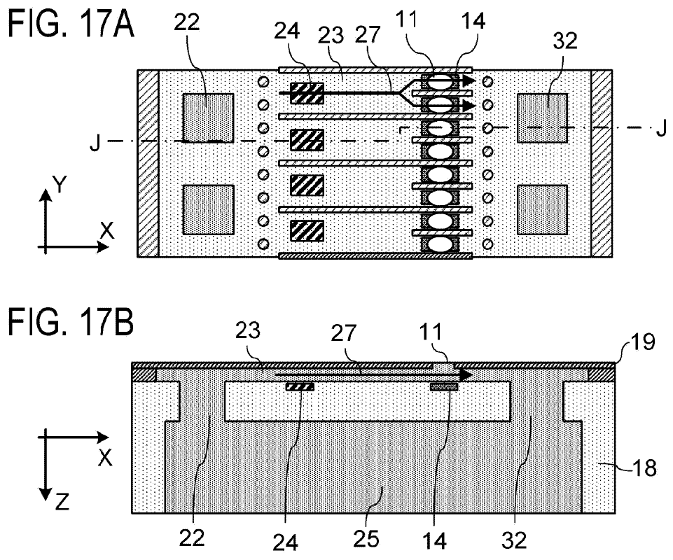

FIGS. 17A and 17B are explanatory diagrams of a flow passage configuration of the liquid ejection head 1 according to the seventh embodiment. FIG. 17A is an explanatory diagram of the configuration of the vicinity of the ejection port 11 of the liquid ejection chip 3. FIG. 17A is a schematic diagram illustrating a positional relationship of the main constituent elements when the liquid ejection chip 3 is viewed in the Z direction. FIG. 17B is a cross-sectional view taken along the line F-F in FIG. 17A.

In the seventh embodiment, each individual flow passage 23 is the straight type and is formed so as to be bifurcated on the way from the inlet to the outlets of the circulation flow 27. The individual flow passage 23 has one inlet located at one end in the X direction and two outlets located at the other end in the X direction. Two pressure chambers 12 (ejection ports 11) are communicated with one individual flow passage 23. Further, two first energy generating elements 14 and one second energy generating element 24 are provided on the substrate 18 for one individual flow passage 23.

The first energy generating element 14 is provided corresponding to each bifurcated flow passage, and is disposed to overlap with the ejection port 11 and the individual flow passage 23 (pressure chamber 12) as viewed in the Z direction, and is disposed closer to the second opening 32 in the X direction. The second energy generating element 24 is provided in a portion that is not bifurcated, and is disposed to overlap with the individual flow passage 23 as viewed in the Z direction, and is disposed closer to the first opening 22 in the X direction. When the second energy generating element 24 is driven, the circulation flow 27 is formed in the individual flow passage 23 in a direction from the first opening 22 side to the second opening 32 side (to the right in FIG. 17A), and the ink in the individual flow passage 23 circulates.

An advantage of such a configuration is that the number of second energy generating elements 24 can be half the number of first energy generating elements 14, such that the number of inter-opening wirings can be reduced.

Here, as a configuration of the on-off-on driving circuit 220, it is necessary to drive the second energy generating element 24 when driving none of the two first energy generating elements 14 in the individual flow passage, and it is necessary to not drive the second energy generating element 24 when both are driven. However, when one of the first energy generating elements 14 is not driven (when only one is driven), both a configuration in which the second energy generating element 24 is driven and a configuration in which the second energy generating element 24 is not driven are conceivable.

The former is a configuration in which the second energy generating element 24 is driven when one of the first energy generating elements 14 is not driven. In such a case, when one of the first energy generating elements 14 is not driven, the second energy generating element 24 is driven to form a circulation flow 27 at the ejection port portion. Therefore, even when only specific one of the first energy generating elements 14 is driven for a long time period, there is an advantage in that the circulation flow 27 of the second energy generating element 24 on the other side can also eliminate concentration at the ejection port portion.

The latter is a configuration in which the second energy generating element 24 is driven only when both first energy generating elements 14 are not driven. When at least one of the first energy generating elements 14 is driven, the second energy generating element 24 is not driven. Therefore, there is an advantage in that driving of the second energy generating element 24 does not have effects on the ejection caused by the driving of the first energy generating element 14.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145472, filed on Aug. 27, 2024, which is hereby incorporated by reference herein in its entirety.

What is claimed is:

1. A liquid ejection head comprising:
a flow passage forming portion including an ejection port through which liquid is ejected, a pressure chamber communicating with the ejection port, and an individual flow passage communicating with the pressure chamber;
a first energy generating element provided at a position corresponding to the pressure chamber of the flow passage forming portion, the first energy generating element is configured to generate energy for ejecting the liquid from the ejection port;
a second energy generating element provided at a position corresponding to the individual flow passage of the flow passage forming portion, the second energy generating element is configured to generate energy for causing the liquid to flow through the individual flow passage; and
a selection driving circuit configured to determine whether to drive the second energy generating element depending on whether to drive the first energy generating element.

2. The liquid ejection head according to claim 1, further comprising:
a control portion configured to control driving of the first energy generating element by sending a control signal for determining a driving state of the first energy generating element,
wherein the selection driving circuit selects and drives only one of the first energy generating element and the second energy generating element on the basis of the control signal for determining the driving state of the first energy generating element.

3. The liquid ejection head according to claim 2,
wherein the selection driving circuit does not drive the second energy generating element in a case where the first energy generating element is driven, and drives the second energy generating element in a case where the first energy generating element is not driven.

4. The liquid ejection head according to claim 1,
wherein the selection driving circuit selectively controls the first energy generating element and the second energy generating element under same time-division control.

5. The liquid ejection head according to claim 1,
wherein the selection driving circuit is configured to determine whether to drive only the first energy generating element, to drive only the second energy generating element, or not to drive both the first energy generating element and the second energy generating element.

6. The liquid ejection head according to claim 1,
wherein the individual flow passage is formed in a straight line shape ranging from a position corresponding to the second energy generating element to a position corresponding to the first energy generating element.

7. The liquid ejection head according to claim 6,
wherein the flow passage forming portion has a first opening for supplying the liquid to the individual flow passage in a case where the second energy generating element is driven, and a second opening for collecting the liquid flowing out from the individual flow passage in a case where the second energy generating element is driven, and
wherein in an extending direction of the individual flow passage, the first opening is disposed on one side with respect to the individual flow passage, and the second opening is disposed on the other side, which is opposite to the one side, with respect to the individual flow passage.

8. The liquid ejection head according to claim 7,
wherein the flow passage forming portion has a plurality of the individual flow passages arranged in a first direction, a plurality of the first openings arranged in the first direction, and a plurality of the second openings arranged in the first direction, and
wherein the liquid ejection head further comprises a plurality of the first energy generating elements and a plurality of the second energy generating elements corresponding to a plurality of the individual flow passages.

9. The liquid ejection head according to claim 8,
wherein the selection driving circuit includes a plurality of wirings connected to the first energy generating elements and the second energy generating elements, and each of the plurality of wirings is disposed on the one side with respect to each of the individual flow passages.

10. The liquid ejection head according to claim 8,
wherein the selection driving circuit includes a plurality of wirings connected to the first energy generating elements and the second energy generating elements, and each of the plurality of wirings is disposed on the other side with respect to each of the individual flow passages.

11. The liquid ejection head according to claim 8,
wherein the selection driving circuit includes a plurality of wirings connected to the first energy generating elements and the second energy generating elements, and among the plurality of wirings, some of the wirings are disposed on the one side with respect to each of the individual flow passages, and some of the wirings are disposed on the other side with respect to each of the individual flow passages.

12. The liquid ejection head according to claim 8,
wherein the selection driving circuit includes a plurality of wirings connected to the first energy generating elements and the second energy generating elements, and the plurality of wirings are disposed so as to pass between two of the first openings adjacent to each other in the first direction.

13. The liquid ejection head according to claim 1,
wherein the individual flow passage is formed in a U-shape ranging from a position corresponding to the second energy generating element to a position corresponding to the first energy generating element.

14. The liquid ejection head according to claim 13,
wherein one end and the other end of the individual flow passage are adjacent to each other in a first direction.

15. The liquid ejection head according to claim 14,
wherein the flow passage forming portion has a plurality of the individual flow passages and a supply groove for supplying the liquid to a plurality of the individual flow passages, and a longitudinal direction of the supply groove is the first direction, and
wherein a plurality of the individual flow passages are arranged in the first direction on one side and the other side with respect to the supply groove in a second direction intersecting with the first direction.

16. The liquid ejection head according to claim 1,
wherein in the individual flow passage, the two pressure chambers and the two first energy generating elements are provided corresponding to each other, and
wherein the individual flow passage is formed to be bifurcated from a position corresponding to the second energy generating element to positions corresponding to the first energy generating elements.

17. The liquid ejection head according to claim 16,
wherein the selection driving circuit drives the second energy generating element in a case where both of the two first energy generating elements are not driven.

18. The liquid ejection head according to claim 16,
wherein the selection driving circuit drives the second energy generating element in a case where only one of the two first energy generating elements is driven.

19. The liquid ejection head according to claim 1,
wherein at least one of the first energy generating element and the second energy generating element is an electro-thermal conversion element.

20. A liquid ejection device comprising:
a conveyance portion configured to convey a recording medium; and
a liquid ejection head configured to eject liquid to a recording medium conveyed by the conveyance portion, the liquid ejection head including:
a flow passage forming portion including an ejection port through which liquid is ejected, a pressure chamber communicating with the ejection port, and an individual flow passage communicating with the pressure chamber;
a first energy generating element provided at a position corresponding to the pressure chamber of the flow passage forming portion, the first energy generating element is configured to generate energy for ejecting the liquid from the ejection port;
a second energy generating element provided at a position corresponding to the individual flow passage of the flow passage forming portion, the second energy generating element is configured to generate energy for causing the liquid to flow through the individual flow passage; and
a selection driving circuit configured to determine whether to drive the second energy generating element depending on whether to drive the first energy generating element.
